(19) United States
(12) Patent Application Publication
(10) Pub. No.: US 2007/0076693 A1
(43) Pub. Date: Apr. 5, 2007

(54) Scheduling variable bit rate multimedia traffic over a multi-hop wireless network

(76) Inventor: Dilip Krishnaswamy, Roseville, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/241,289

(22) Filed: Sep. 30, 2005

(51) Int. Cl. H04L 12/66

(52) U.S. Cl. 370/352; 370/468

(57) ABSTRACT

An arrangement is provided for scheduling VBR multimedia traffic over a multi-hop transmission path in a wireless network so that delivery of the multimedia data over each link may share the available bandwidth of a common channel. A high bit rate and a low bit rate may be used for all of the transmitting nodes (including the source node or all of the intermediary nodes). Transmission bit rate across all of the transmitting nodes may be scheduled using the high and low bit rates in a pipelined manner, under which a high bit rate is used by each link in a round-robin manner. A bit rate over a link may be adjusted according to real-time link conditions of the link at any time.

### BACKGROUND

1. Field

This disclosure relates generally to data transmission in a wireless network and, more specifically, to scheduling variable bit rate multimedia traffic over a multi-hop wireless network.

2. Description

In a wireless communication network (e.g., a 802.11 network), a protocol such as a Carrier Sense Multiple Access with Collision Avoidance (CSMA/CA) protocol) may be used, which may allow only one wireless transmission in progress at a given time in the same channel. Consider a one-way multimedia streaming flow in a wireless network from a source node to a destination node with an intermediary node (e.g., an access point) in between. A packet transmitted from the source node to the intermediary node over a wireless channel may need to be retransmitted over the same channel from the intermediary node to the destination node. Assuming that the network uses a protocol that allows only one wireless transmission at a given time in the same channel, the available bandwidth of the wireless channel needs to be shared between the two hops (i.e., a hop from the source node to the intermediary node and a hop from the intermediary node to the destination node). In other words, transmission from the source node to the intermediary node and transmission from the intermediary node to the destination node may need to share the same wireless channel in a time-division manner.

Typically multimedia data is transmitted in a wireless network using variable bit rates. Considering transmitting a video stream in the wireless network, the video stream may comprise a series of image frames. The size of frames, in terms of bytes, varies from time to time. For example, the size of the first frame may be larger than the size of the second frame because the second frame may only need to contain data representing changes from the first frame. Accordingly, the bit rate used to transmit the first frame may need to be higher than the bit rate used to transmit the second frame. Assume that the multimedia stream is to be transmitted over a two-hop communication path, with an intermediary node between the source node and the destination node. If during a certain period of time, the source node needs to transmit a large frame to the intermediary node, in order for the large frame to reach the destination node without incurring excessive delay and jitter, the source node needs to use a high bit rate and the intermediary node needs to use a low bit rate. In other words, during this period of time, the source node needs to take a large share of the available bandwidth of the channel and the intermediary node needs to scale down its usage of the channel bandwidth accordingly.

Thus, to transmit multimedia data via a multi-hop wireless path over the same wireless channel, it is desirable to schedule the transmission rate at the source node and each of the intermediary nodes in such a manner that the available bandwidth of the channel is most efficiently utilized and the data to be transmitted can be received in the destination node with a high or acceptable quality.

### BRIEF DESCRIPTION OF THE DRAWINGS

The features and advantages of the disclosed subject matter will become apparent from the following detailed description of the present disclosure in which:

FIG. 1 illustrates an example one-way multi-hop wireless communication path in a wireless network;

FIGS. 2A-2C illustrate one example of scheduling variable bit rate multimedia traffic across a multi-hop communication path in a wireless network;

FIGS. 3A-3C illustrate another example of scheduling variable bit rate multimedia traffic across a multi-hop communication path in a wireless network;

FIG. 4A-4C illustrate one example of optimizing scheduling for variable bit rate multimedia traffic across a multi-hop communication path in a wireless network;

FIG. 5 shows one example system that optimizes scheduling for variable bit rate multimedia traffic across a multi-hop communication path in a wireless network; and

FIG. 6 shows a flowchart of one example process of optimizing scheduling for variable bit rate multimedia traffic across a multi-hop communication path in a wireless network.

### DETAILED DESCRIPTION

According to an embodiment of techniques disclosed in this application, delivery of multimedia data via a multi-link communication path over the same channel in a wireless network may be accomplished by efficiently sharing the available bandwidth of the channel among the multiple links. Each link may use variable bit rates to transmit the multimedia data. In one embodiment, two bit rates—a high bit rate and a low bit rate—may be used by each link. These two bit rates may be determined by considering channel conditions for each link as well as the estimated quality of the multimedia data when received by a destination node. One way of effectively sharing the available bandwidth of the channel by the multiple links is to schedule the variable bit rates (e.g., two bit rates) across the links in a pipelined fashion, under which a high bit rate is used by each link in a round-robin manner. A bit rate over a link may also be adjusted according to real-time link conditions of the link at any time. In another embodiment, each link may use bit-rates from a set of bit rates such as {B₁, B₂, . . . Bₖ₋₁} which represents the set of data rates necessary for the variable-bit-rate data flow in the network.

Reference in the specification to “one embodiment” or “an embodiment” of the disclosed subject matter means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

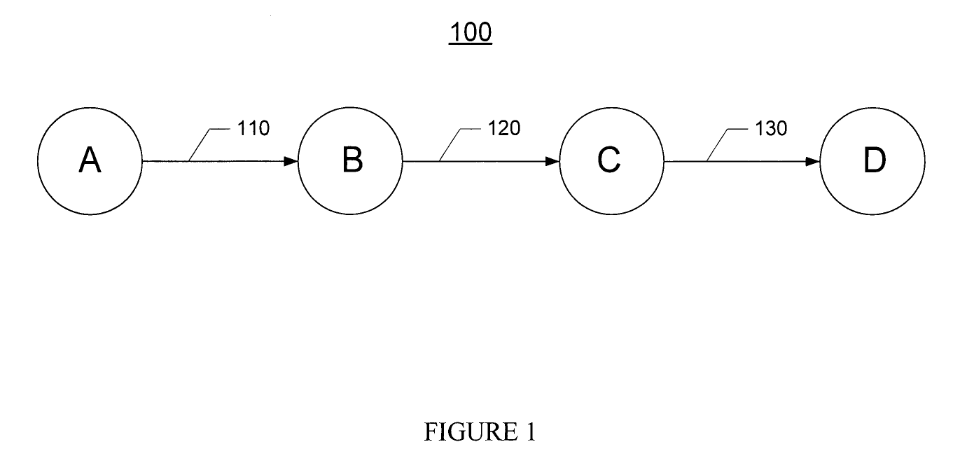

FIG. 1 illustrates an example one-way multi-hop wireless communication path 100 in a wireless network. The path 100 comprises four nodes, A, B, C, and D, which form three transmission links: 110 (from node A to node B), 120 (from node B to node C), and 130 (from node C to node D). Assume that multimedia data is to be transmitted from node A to node D via path 100, that transmissions via links 110, 120, and 130 are over the same channel, and that each of nodes A, B, and C uses variable bit rates to transmit the data. If the wireless network where path 100 is located uses a protocol that allows only one transmission at a given time over the same channel, links 110, 120, and 130 need to share the available bandwidth of the channel, i.e., nodes A, B, and C need to schedule their bit rates in such a way that the available bandwidth of the channel can be effectively utilized.

Consider the last link 130. Assume that the multimedia data is a real video stream with large-sized packets being transmitted at certain times, and smaller sized packets being transmitted at other times. Assume that the peak average bandwidth required for the transmission of the large-sized packets is Bmax, and the peak average bandwidth required for the remaining duration of time is Bmin. Assume that over a period of time T, a fraction λ of time requires a guarantee of Bmax bandwidth over the channel, and the remaining fraction of the time (1−λ) requires a guarantee of bandwidth Bmin over the channel. The average bandwidth required over the channel is then, Bavg=λBmax+(1−λ) Bmin. For node D to receive the video stream in a good and/or acceptable quality, bit rates at nodes A, B, and C need to be scheduled properly to guarantee a bandwidth of Bmax for link 130 during the time duration λT and a bandwidth of Bmin for link 130 during the time duration (1−λ)T.

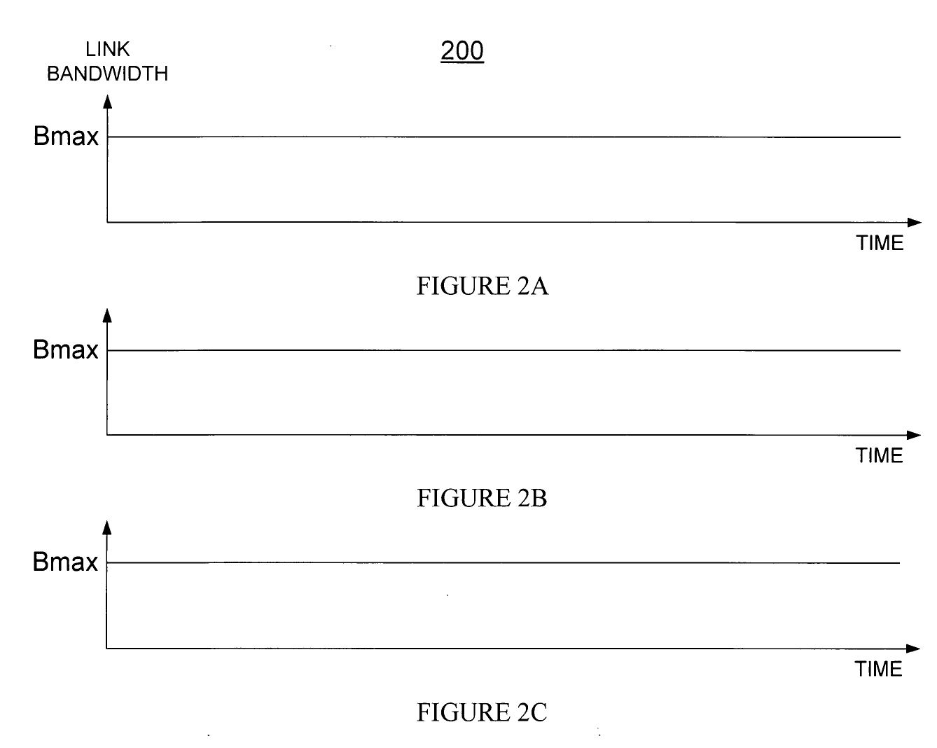

FIGS. 2A-2C illustrate one example 200 of scheduling bit rates for nodes A, B, and C to transmit a real-time video stream over the communication path 100 shown in FIG. 1. FIG. 2A shows the bandwidth usage by link 110 over time; FIG. 2B shows the bandwidth usage by link 120 over time; and FIG. 2C shows the bandwidth usage by link 130 over time. Because links 110, 120, and 130 have to share the available bandwidth of the channel, Bavail, transmission of data from nodes A, B, and C during a given period of time needs to be accomplished in a time-division manner. If Bavail<3Bmax, however, not all of nodes A, B, C, will be able to transmit their required amount of data within a required period of time. As a result, excessive delay may occur and the quality of the video received at node D may be affected. On the other hand, the bandwidth resource is wasted by providing a link a guarantee of Bmax during a period of time when the link only needs a guarantee of Bmin.

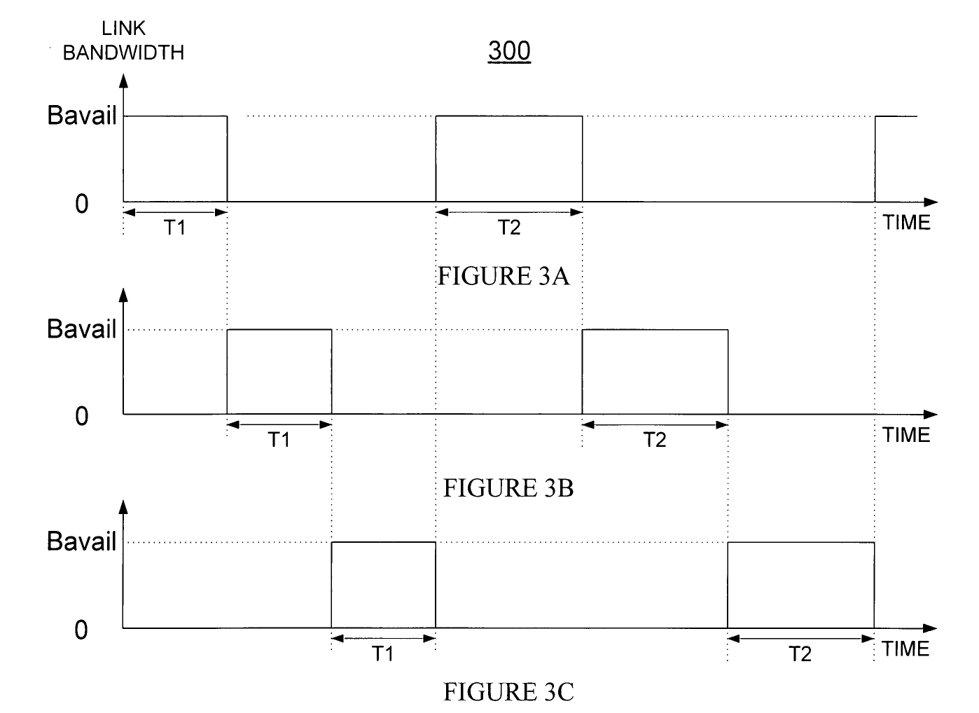

FIGS. 3A-3C illustrate another example 300 of scheduling bit rates for nodes A, B, and C to transmit a real-time video stream over the communication path 100 shown in FIG. 1, with FIG. 3A for link 110, FIG. 3B for link 120, and FIG. 3C for link 130. In example 300, during any period of time one link is allowed to use the entire available bandwidth and other links are not allowed to use any portion of the available bandwidth. For example, during the first time period of T1, link 110 uses up the entire available bandwidth and links 120 and 130 cannot use any portion of the bandwidth; during the second time period of T1, it is link 120's turn to use up the entire available bandwidth; during the third time period of T1, link 130 uses up the entire available bandwidth; and so on. This scheduling scheme shown in example 300 may work for some types of data, but it does not work for other types of data such as a real-time video stream, which may require that node D receive some amount of data during any given period of time.

As described in FIGS. 2A-2C, if Bavail<3Bmax, there is not enough bandwidth to support traffic at Bmax for links 110, 120, and 130 at the same time. However, if Bavail>(Bmax+2Bmin) or Bavail>(2Bmax+Bmin), the network is capable of supporting traffic of bandwidth of Bmin on one or two of the links when traffic of bandwidth Bmax is required on the other one or two links. Thus, if traffic on links 110 and/or 120 are scheduled such that the requirements on links 110 and/or 120 are only Bmin when the requirements on link 130 is Bmax, then the bandwidth requirements on link 130 can be supported. When the bandwidth need on link 130 drops to Bmin, Bmax can be delivered to link 110 or 120.

Although a 3-link wireless communication path is used as an example above, the same principle can be easily extended to a general one-way multi-hop wireless communication path, A₁→A₂→A₃→ . . . →Aₖ, with a multimedia transmission in progress in the path, where node A₁ is a multimedia source, and node Aₖ is the final destination (e.g., a digital media adaptor). Let L₁, L₂, L₃, . . . Lₖ₋₁ represent links between two adjacent nodes with link Lᵢ representing the link between nodes Aᵢ to Aᵢ₊₁. Assume that λ<=1/(k−1), and that (k−1)×Bmax>Bavail>(Bmax+(k−2) Bmin). When the last link Lₖ₋₁ (i.e. Aₖ₋₁→Aₖ) requires bandwidth Bmax, the remaining links operate at bandwidths such that the sum of these bandwidths on the remaining links is less than (Bavail−Bmax). Subsequently as link Lₖ₋₁ drops its bandwidth requirements to Bmin, another link (e.g., L₁) may be scheduled for a bandwidth requirement of Bmax, with the remaining links requiring a cumulative bandwidth of (Bavail−Bmax). The scheduling of transmissions at rate Bmax can be scheduled such that all other transmissions require only a cumulative bandwidth of (Bavail−Bmax), so that the next time the last link Lₖ₋₁ requires the bandwidth Bmax, data is already available at the node Aₖ₋₁ to be forwarded in time to node Aₖ, ensuring variable bit rate (“VBR”) multimedia delivery in time at the destination node Aₖ at the desired average bandwidth Bmax. To achieve such a pipelined scheduling of bit rates across different nodes, each node needs to have a sufficient buffer to temporarily store data received from its preceding node, which cannot be delivered immediately to the next node.

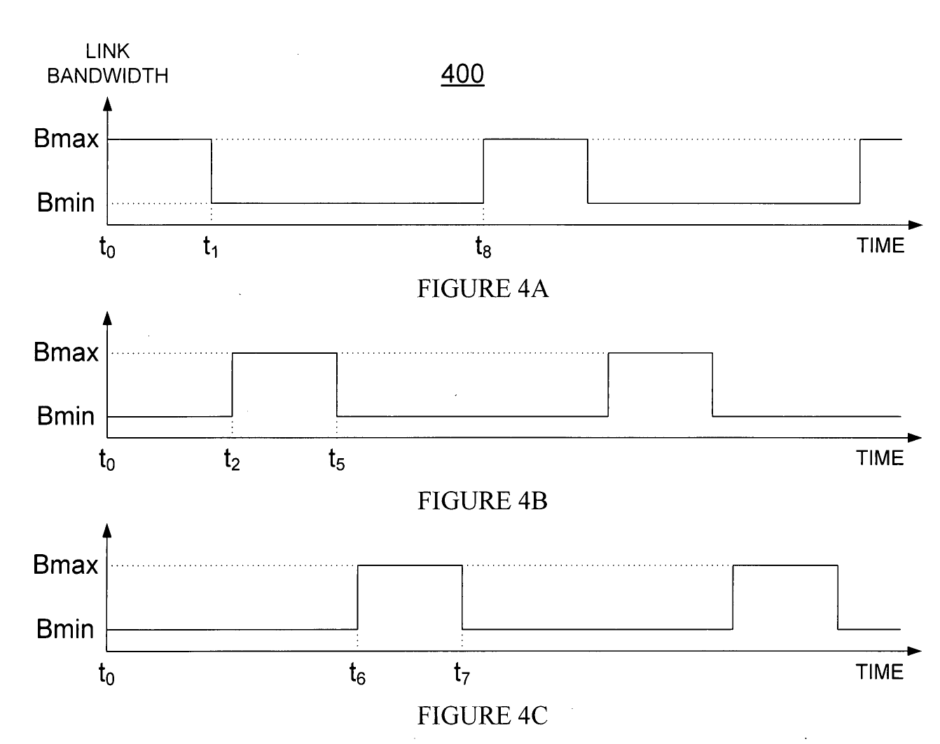

FIGS. 4A-4C illustrate one example 400 of optimizing scheduling for VBR multimedia traffic across a multi-hop communication path in a wireless network. Example 400 uses the wireless communication path 100 as the example and shows how to schedule bit rates for nodes A, B, and C to transmit a real-time video stream over path 100, with FIG. 4A for link 110, FIG. 4B for link 120, and FIG. 4C for link 130. Assume that in FIGS. 4A-4C, t₀<=t₁<=t₂<=t₃<=t₄<=t₅<=t₆<=t₇. When one of the links in path 100 has high bandwidth requirements for packet transfers over the network, the other links can scale down on their requirements to ensure efficient transfer of the traffic across the hops in an efficient pipelined manner. For example, if link 110 requires a high bandwidth (e.g., Bmax) to deliver a large packet from t₀ to t₁, links 120 and 130 may use a lower bandwidth (e.g., Bmin) from t₀ to t₁ to ensure that the large packet can be delivered from node A to node B without excessive delay and/or jitter. After link 110 delivers that large packet, link 110 may scale down its bandwidth requirement to a value (e.g., Bmin) which can transmit enough data to ensure that the destination node D will eventually receive the real-time video with an acceptable quality; other links (e.g., link 120) may now use a high bandwidth (e.g., Bmax) to deliver a packet received and/or stored in a buffer. The pipelined scheduling can go on until the entire real-time video is fully received at the destination node D.

Although only two bandwidth values (e.g., Bmax and Bmin) are used in FIGS. 4A-4C, links are not limited to these two values and they can use any values required to ensure that a good quality of the real-time video stream be received at node D, so long as the total sum of these values used by all the links does not exceed the total available bandwidth of the channel, Bavail. Additionally, links are not required to use up the entire Bavail at any give period of time. For example, if none of the links require a high bandwidth from t₅ to t₆ (assume that t₅<t₆), all of the links can use a low bandwidth value so that the remaining bandwidth of the channel may be used by other traffics. Note that with network protocols (e.g., CSMA/CA) which allow only one node to transmit at any given time while other nodes wait for their turns to transmit, all the nodes in the multi-hop path may deliver their data in a time-division manner. For example, in a time interval ΔT, it is possible that a large fraction of the time may be used by the node that needs to transfer packets at a high data rate, which may involve several packet transfers; other nodes may transfer their data at a low data rate during such a period of time. Bandwidth values shown in FIGS. 4A-4C only indicate the average bandwidth requirement for each of the nodes during a time interval. In the above discussions, it is assumed that Bmax is smaller than the minimum of the maximum bandwidth sustainable on each of the links based on link conditions.

In general, in a wireless network, the channel conditions on the links are expected to be different, and the modulation and coding scheme (“MCS”) being used on each link may differ. The effective link bandwidth during a period of time ΔT is given by the number of bytes successfully transmitted over the link divided by the time period ΔT. Over a period of time T, since all links can be expected to be different, fractions of time ΔTⱼ=λⱼT may be required to be allocated during which one link has an effective bandwidth of Bmax while other links have an effective bandwidth of Bmin (such that (Bmax+(k−2) Bmin≦Bavail). Each link may have its fraction of time when the higher-bandwidth burst transfer at Bmax bandwidth is enabled. Since ΣΔTⱼ≦T for a pipelined data flow, this imposes a constraint.

Further generalization may be extended to links having effective bandwidths B₁, B₂, . . . Bₖ₋₁ in a given fractional time period ΔT_{j.}=λⱼT. Here Bmax=max(B₁, B₂, . . . Bₖ₋₁) and Bmin=min(B₁, B₂, . . . Bₖ₋₁). In a pipelined data flow all (k−1) links take turns in assuming these bandwidth requirements such that
ΣBⱼ≦Bavail (1)
in any given time period ΔTⱼ. It should be noted that this is a more relaxed requirement compared to guaranteeing a bandwidth of Bmax on all (k−1) links all of the time, in which case it requires that Bavail≧(k−1)Bmax. Therefore, a knowledge of the VBR nature of the data flow may be used to improve the capacity of the network by relaxing the restrictions on the bandwidths required to be supported on the links in the multi-hop network, with each link supporting high bandwidths at certain times, and low bandwidths at other times, to maintain the pipelined data flow for the VBR data traffic in the network.

The pipelined data flow may require the constraint

$${\sum }_{i = 1}^{k - 1} {λ}_{i} \leq 1. \qquad ( 2 )$$

to be satisfied for the overall flow in a multi-hop wireless network. If there are other wireless transmissions that share the network medium that may take place only when VBR transmissions are not in progress, and such transmissions may take a fraction of network time given by β, then it may needs to be ensured that an amount of time βT is budgeted for such transmissions in every period of fractional time T. Accordingly, Equation (2) needs to be replaced by the equation:

$${\sum }_{i = 1}^{k - 1} {λ}_{i} \leq ( 1 - β ) . \qquad ( 3 )$$

When β=0, equation (3) reduces to equation (2), and this is a more general constraint for the wireless transmissions in the network.

When using centralized bandwidth protocols, an access point may be required to continually reallocate bandwidths for each of the links for every fractional time period, to make optimal usage of network resources while comprehending the requirements for the VBR data flow in the network. In each fractional period of time ΔTⱼ, let us assume that link i needs to guarantee bandwidth B_{i,j}. The links have bandwidths {B_{i,j}, B_{2,j}, B_{3,j}, . . . B_{k-1,j}} which are assigned with a bijective mapping to the set {B₁, B₂, . . . Bₖ₋₁} that is used for the pipelined VBR data flow. The amount of data transferred over link i is given by B_{i,j}×ΔTⱼ. Link adaptation on the link i is expected to choose the highest throughput MCS with a low packet error rate. Let the effective throughput on this link be Lᵢ. This effective throughput assumes overheads due to inter-frame spacing, time required for acknowledgements, and backoff time, which may be required by the wireless protocol being used for transmission by the wireless links. Then, the actual time on the network required for transmission by the link i is given by
ΔT_{i,j}=(B_{i,j}ΔTⱼ/Lᵢ) (4)
The sum of the times occupied by all the links during this period of time ΔTⱼ should satisfy ΣΔT_{i,j}≦ΔTⱼ. If we represent μ_{i,j}=ΔT_{i,j}/ΔTⱼ, then this equation is equivalent to the constraint

$${\sum }_{i = 1}^{k - 1} {μ}_{i , j} \leq 1 \qquad ( 5 )$$

being satisfied in the fractional period ΔTⱼ. Equation (5) needs to be satisfied for every factional period ΔTⱼ (j=1, 2, . . . , (k−1)).

If there are other wireless transmissions that share the network medium along with the VBR transmissions during a period ΔTⱼ, that may take a fraction of network time given by kⱼ, it needs to be ensured that an amount of time kⱼ ΔTⱼ is budgeted for such transmissions in every period of fractional time ΔTⱼ. Equation (5) should then be replaced by the equation:

$${\sum }_{i = 1}^{k - 1} {μ}_{i , j} \leq ( 1 - {κ}_{j} ) . \qquad ( 6 )$$

When kⱼ=0, Equation (6) reduces to Equation (5), and hence Equation (6) is a more general constraint for wireless transmissions in the network. Equation (3) ensures that performance and delay constraints related to the delivery of the multimedia stream can be satisfied. Equation (6) ensures that all links are able to meet their bandwidth requirements in every fractional period of time ΔTⱼ. In the event that Equation (3) or Equation (6) is not satisfied, the values of the bandwidths in the set {B₁, B₂, . . . Bₖ₋₁} may be scaled down to lower values such that the equations is satisfied. Whenever Equation (3) or Equation (6) is satisfied, experiment may be done to increase the values of the bandwidths in the set {B₁, B₂, . . . Bₖ₋₁} to higher values to approach network capacity while ensuring that the equations are satisfied.

When conditions deteriorate on one of the links (say link j), link adaptation at the link may require the link to be operated in a more robust MCS, which reduces the maximum throughput available on the link. This may require additional time on the network for that link to meet its bandwidth requirements. If there is additional time available in the network such that equations (3) and (6) are satisfied, such time may be allocated for the link as required by equation (4). Alternatively, the bandwidths specified in the set {B₁, B₂, . . . Bₖ₋₁} may have to be reduced to meet the constraints in equations (3) and (6).

When conditions improve on one or more links, link adaptation will allow the link(s) to start transmitting using a higher-throughput MCS. This relaxes constraints specified in equations (3), (4), and (6), and may be used to increase the values of the bandwidths specified by the set {B₁, B₂, . . . Bₖ₋₁},so that higher data rates can be supported by the network as conditions in the network improve.

Therefore, the constraints in equations (3) and (6) can be used to dynamically adapt supported bandwidths for the wireless transmissions in the multi-hop network by attempting to maximally approach the capacity of the network for the VBR data transmissions.

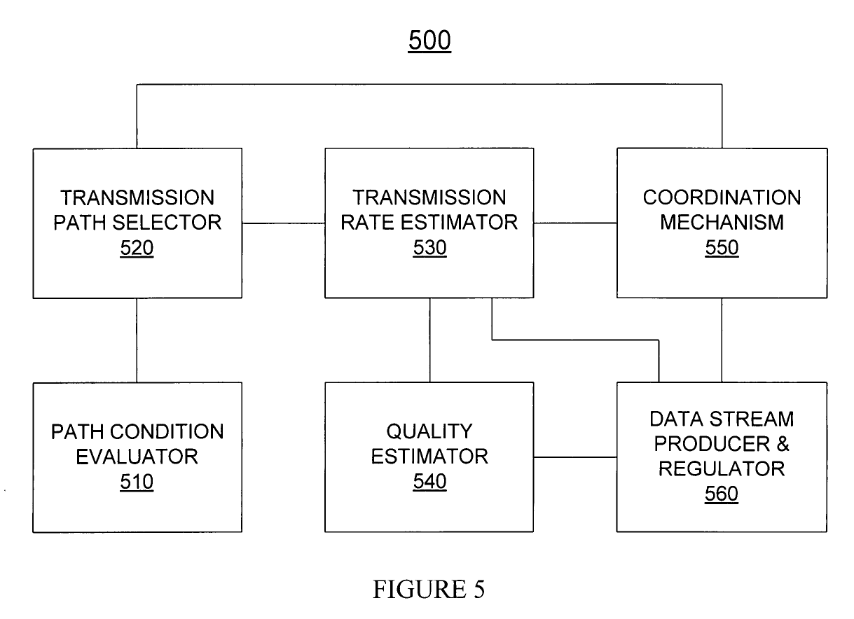

FIG. 5 shows one example system 500 that optimizes scheduling for VBR multimedia traffic across a multi-hop communication path in a wireless network. System 500 comprises a path condition evaluator 510, a transmission path selector 520, a transmission rate estimator 530, a quality estimator 540, a coordination mechanism 550, and a data stream producer & regulator 560. Path condition evaluator 510 accepts a request for transmitting multimedia data from a source node to a destination node. Upon receiving the request, the path condition evaluator searches in the network for all available paths that connect between the source node and the destination node. For each of the possible paths, the path condition evaluator evaluates its quality by measuring parameters such as the available bandwidth under the current channel condition.

Based at least in part on evaluation results obtained by the path condition evaluator, transmission path selector 520 may select a path that has the best quality to transmit the multimedia data from the source node to the destination node. The transmission path selector also maintains the information regarding the number of intermediary nodes between the source node and the destination node.

Transmission rate estimator 530 estimates at least one high bit rate and one low bit rate for each transmitting node (including the source node and any intermediary node) based at least in part on the multimedia data to be transmitted, the available bandwidth of the selected transmission path, as well as the quality of the data, when received by the destination node, estimated by quality estimator 540.

For example, if the multimedia data to be transmitted is a real-time video stream, the transmission rate estimator may determine an initial set of transmitting bit rates for each transmitting node by using the information such as the size of packets/frames and the upper time limit within which each packet/frame has to be transmitted to the next node in order for the destination node to receive the video stream with a reasonable quality. Each initial set of transmitting bit rates includes at least two rates: one represents a high bit rate for those large packets/frames and one represents a low bit rate for other packets/frames. An estimated transmitting bit rate for a packet/frame may be obtained by dividing the size of the packet/frame (in bits) by the upper time limit within which the packet/frame has to be transmitted by a transmitting node. If the highest bit rate in an initial set of transmitting bit rates is higher than the available bandwidth of the link which is used to transmit data from the transmitting node to the next node in the selected transmission path, the transmission rate estimator may reduce the highest bit rate to the available bandwidth of the link in one embodiment. In another embodiment, if available bandwidths of links in the selected path cannot guarantee that the multimedia data be received at the destination node with an acceptable quality, the transmission path estimator may inform the source of the multimedia data to wait until the condition of the transmission path improves or other paths with an available bandwidth higher than the highest initial transmitting bit rate become available.

Each initial set of transmitting bit rates may include many different rates. In one embodiment, the transmission rate estimator may reduce the number of rates across all of the initial sets to two values—one high rate and one low rate—for the convenience of rate scheduling across the transmitting nodes. In another embodiment, the transmission rate estimator may maintain a separate pair of a high bit rate and a low bit rate for each transmitting node. The transmission rate estimator may further adjust values of the high bit rate and the low bit rate for each transmitting node according to the available bandwidth sustainable by each link in the transmission path (e.g., based on Equations (3) and (6) above), and the estimated quality of the multimedia data received by the destination node, provided by the quality estimator.

Quality estimator 540 estimates the quality of the multimedia data, when received by the destination node, according to the transmission bit rates used by each transmitting node. The estimated quality may be used by the transmission rate estimator to determine the initial set of transmitting bit rate and to adjust the values of the transmitting bit rates for each transmitting node. The estimated quality may also be used by data stream producer & regulator to produce/regulate the data stream to be transmitted across the selected transmission path.

Coordination mechanism 550 works with transmission rate estimator 530 and data stream producer & regulator 560 to schedule transmitting bit rates for each transmitting node. Because data transmitted by more than one transmitting node may share the same channel, the coordination mechanism may schedule the bit rates in a pipelined manner as illustrated in FIGS. 4A-4C and described therein. In one embodiment, the coordination mechanism may schedule bit rates across the transmitting nodes by passing a token forward from the source node in a round-robin manner. Only a node with the token can transmit the data to the next node at a high bit rate relative to other transmitting nodes. In another embodiment, approaches such as the Wi-Fi multimedia—scheduled access (WMM-SA) based approach may be used to ensure a pipelined schedule of transmitting bit rates across different transmitting nodes.

Data stream producer & regulator 560 may produce a data stream for each transmitting node according to the scheduled bit rates provided by coordination mechanism 550 and transmission rate estimator 530. For each intermediary node, the data stream producer & regulator may regulate a data flow by temporarily storing at least a portion of the data received from its preceding node. Because the condition for each link in the transmission path may vary from time to time, the transmission rate estimator may adjust the bit rates for each transmitting rate and the coordination mechanism may re-schedule the bit rates for each transmitting rate. Accordingly, the data stream producer & regulator may regulate the data stream for each transmitting node. Quality estimator 540 may also provide feedback to the data stream producer & regulator so that it can produce/regulate/re-produce the data stream accordingly.

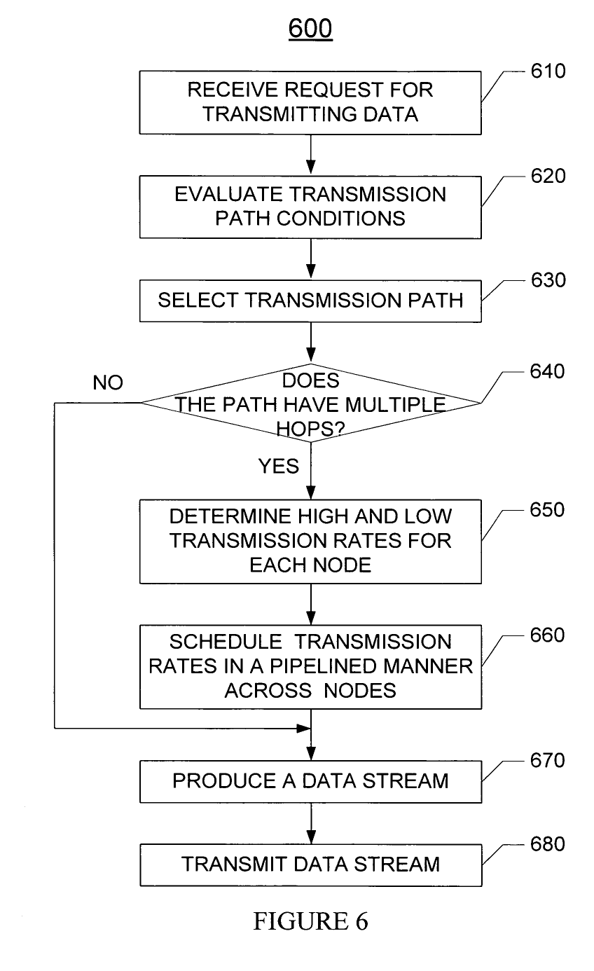

FIG. 6 shows a flowchart of one example process 600 of optimizing scheduling for variable bit rate multimedia traffic across a multi-hop communication path in a wireless network. At block 610, a request for transmitting multimedia data from a source node to a destination node may be received. At block 620, all of the available transmission paths connecting the source node and the destination node may be identified, and conditions of these paths may be evaluated. The evaluation of path conditions may be performed by estimating the available bandwidth of a path. At block 630, the path that has the highest available bandwidth may be selected to transmit the multimedia data from the source node to the destination node. The available bandwidth and the information regarding the number of intermediary nodes between the source node and the destination node may also be retained for the selected transmission path.

At block 640, the selected path may be examined to determine if it has any intermediary nodes between the source node and the destination node. If the selected transmission path does not have any intermediary node (i.e., the path is not a multi-hop path), a data stream may be produced for the multimedia data at block 670, according to the available bandwidth of the selected path. In such a case, the average transmitting bit rate at the source node may be set to a value equal or close to the available bandwidth of the path during any given time period. If the available bandwidth of the path changes due to a change of path conditions, the data stream may need to be adjusted to reflect the change of the available bandwidth of the path. The produced data stream may then be transmitted directly from the source node to the destination node at block 680.

If the selected transmission path has at least one intermediary node (i.e., the path is a multi-hap path), at least a high average bit rate and a low average bit rate may be determined for each transmitting node (i.e., the source node and each intermediary node) at block 650. In one embodiment, each transmitting node may have the same high average bit rate and the same low average bit rate. In another embodiment, the high average bit rate and the low average bit rate may be different from one transmitting node to another. In determining the high and low average bit rates, several factors may be considered. For example, the size of frames/packets in the multimedia data and the transmission time period of a frame/packet which is permissible to ensure an acceptable quality of the multimedia data at the destination node may be used to determine an initial set of bit rates for each frame/packet in the multimedia data for each transmitting node. This may result in more than two bit rates for each transmitting node. In one embodiment, the same high bit rate and the same low bit rate may be used for all of the transmitting nodes. In another embodiment, each transmitting node may have its own high bit rate and the low bit rate. The high bit rate and the low bit rate may also be adjusted according to changes of link conditions. For example, if a link cannot sustain the high bit rate, the high bit rate for that link may be adjusted to the bandwidth sustainable by the link and the time period of using the high bit rate may be adjusted according to Equations (3) and (6). Furthermore, the high bit rate and the low bit may be adjusted according the estimated quality of the multimedia data, when received at the destination node.

At block 660, bit rates used by each transmitting node may be scheduled in a pipelined manner as illustrated in FIGS. 4A-4C. In one embodiment, the pipelined scheduling of bit rates across the transmitting nodes may be achieved by passing a token from the source node forward in a round-robin fashion. Only a transmitting node that has the token can use the high bit rate. In another embodiment, the pipelined scheduling of bit rates across the transmitting nodes may be achieved by using coordination mechanisms such as WMM-SA. After the bit rates across the transmitting nodes are scheduled, a data stream may be produced according to the scheduled bit rates for the source node. The source node may then transmit the produced data stream to the next intermediary node. At each intermediary node, a portion or all of the received data may need to be buffered so that the intermediary node can transmit data according to the scheduled bit rates for this node. The multimedia data may be received by the destination node from the last intermediary node.

Although an example embodiment of the disclosed subject matter is described with reference to block and flow diagrams in FIGS. 1-6, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method for scheduling multimedia data transmission in a wireless network, comprising:
receiving a request for transmitting multimedia data from a source node to a destination node in said network;
selecting a transmission path from said source node to said destination node; and
if said transmission path has at least one intermediary node between said source node and said destination node, scheduling transmission rates in a pipelined manner at said source node and each of said at least one intermediary node.

2. The method of claim 1, wherein selecting a transmission path from said source node to said destination node comprises:
identifying available transmission paths from said source node to said destination node;
estimating the available bandwidth for each of said available transmission paths; and
selecting, among said available transmission paths, one that has the highest available bandwidth as said transmission path.

3. The method of claim 2, further comprising if said transmission path has no intermediary node between said source node and said destination node,
producing a data stream using the available bandwidth of said transmission path at said source node; and
transmitting said data stream from said source node to said destination node.

4. The method of claim 1, wherein scheduling transmission rates in a pipelined manner comprises:
determining a first transmission rate and a second transmission rate for said source node and each of said at least one intermediary node; and
scheduling transmission of said multimedia data in a pipelined manner using at least said first transmission rate and said second transmission rate for said source node and each of said at least one intermediary node.

5. The method of claim 4, wherein determining a first transmission rate and a second transmission rate comprises:
determining a first initial transmission rate and a second initial transmission rate based on said multimedia data;
estimating the quality of said multimedia data, when received by said destination node, based on said first initial transmission rate and said second initial transmission rate; and
adjusting said first initial transmission rate and said second initial transmission rate according to the estimated quality to obtain said first transmission rate and said second transmission rate.

6. The method of claim 4, wherein scheduling transmission of said multimedia data in a pipelined manner comprises using said first transmission rate by said source node and each of said at least one intermediary node in a round-robin order, said first transmission rate being higher than said second transmission rate.

7. The method of claim 4, further comprising:
producing a data stream for said multimedia data at said source node using said first transmission rate and said second transmission rate according to said pipelined manner; and
transmitting said data stream from said source node to said destination node.

8. The method of claim 7, further comprising:
buffering at least a portion of received data, if necessary, at each of said at least one intermediary node so that each of said at least one intermediary node transmits said multimedia data using said first transmission rate and said second transmission rate according to said pipelined manner; and
receiving said multimedia data by said destination node.

9. An apparatus for scheduling multimedia data transmission in a wireless network, comprising:
a transmission path selector to receive a request for transmitting multimedia data from a source node to a destination node and to select a transmission path between said source node and said destination node in said network; and
a coordination mechanism to schedule transmission rates in a pipelined manner at said source node and each of said at least one intermediary node, if said transmission path has at least one intermediary node between said source node and said destination node.

10. The apparatus of claim 9, further comprising a path condition evaluator to identify available transmission paths from said source node to said destination node and to estimate the available bandwidth for each of said available transmission paths.

11. The apparatus of claim 10, wherein said transmission path selector selects, among said available transmission paths, one that has the highest available bandwidth as said transmission path.

12. The apparatus of claim 9, further comprising a node transmission rate estimator to determine a first transmission rate and a second transmission rate for said source node and each of said at least one intermediary node.

13. The apparatus of claim 12, wherein said coordination mechanism schedules transmission of said multimedia data in a pipelined manner by using said first transmission rate by said source node and each of said at least one intermediary node in a round-robin order, said first transmission rate being higher than said second transmission rate.

14. The apparatus of claim 12, further comprising a quality estimator to estimating the quality of said multimedia data, when received by said destination node, based on said first transmission rate and said second transmission rate.

15. The apparatus of claim 14, wherein said node transmission rate estimator adjusts said first transmission rate and said second transmission rate according to the estimated quality.

16. The apparatus of claim 13, further comprising a data stream producer & regulator to produce and regulate a data stream using the available bandwidth of said transmission path at said source node, if said transmission path has no intermediary node between said source node and said destination node; and otherwise, to produce and regulate a data stream for said multimedia data at said source node using said first transmission rate and said second transmission rate according to said pipelined manner and to buffer at least a portion of received data, if necessary, at each of said at least one intermediary node so that each of said at least one intermediary node transmits said multimedia data using said first transmission rate and said second transmission rate according to said pipelined manner.

17. An article comprising a machine-readable medium that contains instructions, which when executed by a processing platform, cause said processing platform to perform operations comprising:
receiving a request for transmitting multimedia data from a source node to a destination node in said network;
selecting a transmission path from said source node to said destination node; and
if said transmission path has at least one intermediary node between said source node and said destination node, scheduling transmission rates in a pipelined manner at said source node and each of said at least one intermediary node.

18. The article of claim 17, wherein selecting a transmission path from said source node to said destination node comprises:
identifying available transmission paths from said source node to said destination node;
estimating the available bandwidth for each of said available transmission paths; and
selecting, among said available transmission paths, one that has the highest available bandwidth as said transmission path.

19. The article of claim 18, wherein said operations further comprises if said transmission path has no intermediary node between said source node and said destination node,
producing a data stream using the available bandwidth of said transmission path at said source node; and
transmitting said data stream from said source node to said destination node.

20. The article of claim 17, wherein scheduling transmission rates in a pipelined manner comprises:
determining a first transmission rate and a second transmission rate for said source node and each of said at least one intermediary node; and
scheduling transmission of said multimedia data in a pipelined manner using at least said first transmission rate and said second transmission rate for said source node and each of said at least one intermediary node.

21. The article of claim 20, wherein determining a first transmission rate and a second transmission rate comprises:
determining a first initial transmission rate and a second initial transmission rate based on said multimedia data;
estimating the quality of said multimedia data, when received by said destination node, based on said first initial transmission rate and said second initial transmission rate; and
adjusting said first initial transmission rate and said second initial transmission rate according to the estimated quality to obtain said first transmission rate and said second transmission rate.

22. The article of claim 20, wherein scheduling transmission of said multimedia data in a pipelined manner comprises using said first transmission rate by said source node and each of said at least one intermediary node in a round-robin order, said first transmission rate being higher than said second transmission rate.

23. The article of claim 20, wherein said operations further comprises:
producing a data stream for said multimedia data at said source node using said first transmission rate and said second transmission rate according to said pipelined manner;
transmitting said data stream from said source node to said destination node.
buffering at least a portion of received data, if necessary, at each of said at least one intermediary node so that each of said at least one intermediary node transmits said multimedia data using said first transmission rate and said second transmission rate according to said pipelined manner; and
receiving said multimedia data by said destination node.
